(19) United States
(12) Patent Application Publication
(10) Pub. No.: US 2010/0062124 A1
(43) Pub. Date: Mar. 11, 2010

(54) Process for Producing a Mineral Whey Product

(75) Inventor: Michael John Phillips, Victoria (AU)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: MURRAY GOULBURN CO-OPERATIVE CO LIMITED, Brunswick, Victoria (AU)

(21) Appl. No.: 11/917,952

(22) PCT Filed: Jun. 23, 2006
(86) PCT No.: PCT/AU2006/000886

§ 371 Date: Oct. 21, 2009

(30) Foreign Application Priority Data
Jun. 23, 2005 (AU) 2005903308

(51) Int. Cl. A23C 21/00

(52) U.S. Cl. 426/271; 426/422; 426/583

(57) ABSTRACT

A process for the production of a commercial mineral whey product derived from a feed stream of milk or whey, said process including the steps of: primary de-mineralisation of the feed stream, preferably carried out by either membrane separation or ion exchange to produce a high potassium stream and a demineralised stream; secondary demineralisation of the high potassium stream, either by precipitation and subsequent separation of a predominantly calcium-phosphate complex, or by the removal of calcium by ion exchange; concentrating the high potassium stream to obtain a concentrate having a total solids content of around 20 to 60% by weight; and further processing of said concentrated said high potassium stream into a desired form for storage and distribution.

### FIELD OF THE INVENTION

The invention relates to the commercial processing of dairy-derived materials. In particular, it relates to an improved process for the production of a relatively high potassium product derived from commercial whey.

### BACKGROUND TO THE INVENTION

The balance of sodium to potassium in many commercially prepared foods in the developed world tends to be higher than recommended by nutritionists. Consequently, it is desirable to be able to prepare foods that deliver closer to a desirable sodium to potassium profile.

One approach to addressing this problem is to extract a mineral-rich material from dairy products. This is described in U.S. Pat. No. 6,399,140 issued to Valio Ltd (‘the Valio patent’). The Valio patent describes the manufacture of a mineral-rich extract of whey via nanofiltration and concentration processes.

However, the process described in the Valio patent tends to cause an unacceptably high level of fouling of processing equipment. In particular, the apparatus used to concentrate the milk salt stream prior to drying can become unacceptably fouled when this prior art method is executed.

Therefore, in order to reduce fouling, and thereby improving the efficiency and feasibility of a commercially viable process, it is an object of the invention to provide a process for the manufacture of a milk salt product derived from dairy-based feed stock which overcomes the fouling problems associated with the prior art, whilst not adversely affecting the flavour profile or the functional properties of the high potassium product produced thereby.

### SUMMARY OF THE INVENTION

According to one aspect of the invention, there is provided a process for the production of a commercial mineral whey product derived from a feed stream of milk or whey, said process including the steps of:

primary de-mineralisation of the feed stream, preferably carried out by either membrane separation or ion exchange to produce a high potassium stream and a demineralised stream;

secondary demineralisation of the high potassium stream, either by precipitation and subsequent separation of a predominantly calcium-phosphate complex, or by the removal of calcium by ion exchange;

concentrating the high potassium stream to obtain a concentrate having a total solids content of around 20 to 60% by weight; and

further processing of said concentrated said high potassium stream into a desired form for storage and distribution.

Said further processing preferably includes removal of moisture to produce a concentrate, paste or powder.

It has been determined by the inventors that the above-mentioned calcium-phosphate complex is primarily responsible for the fouling problems associated with the prior art processes. An important advantage of the present invention, therefore, is that the secondary demineralisation stage removes those minerals which contribute to these fouling problems. Further, it has been found that this process step does not adversely affect the flavour profile or the functional performance of the mineral whey product produced thereby, and in fact significantly improves the solubility of the resulting mineral whey product, particularly where the calcium content of the final product is less than 0.5% by mass on a dry solids basis. This is particularly useful where the whey product is to be used as an ingredient in a food product where translucency is a desirable characteristic of the food.

Preferably, said precipitation of the calcium-phosphate complex is achieved by heating said high potassium stream to a precipitation temperature of between 50° C. and 99° C. and holding said high potassium stream in that temperature range for a minimum holding time.

This precipitation process has been found to provide a particularly advantageous result with respect to providing a mineral whey product with an acceptable flavour profile and without adverse affect on the functional performance of the mineral whey product.

In particular, it is preferred that the precipitation temperature is approximately 80° C.

Advantageously, said minimum holding time of said high potassium stream at the precipitation temperature is between 2 and 60 minutes, and most preferably is approximately 20 minutes.

In addition, said precipitation of the calcium-phosphate complex can be further enhanced by increasing the pH of said high potassium stream to the range of pH 6.5 to 9.0, and more preferably within the range 7.0 to 7.5. This approach is appropriate where it is not critical that the resulting whey mineral product is pure, as it will thereby contain a non-dairy additive (e.g. potassium hydroxide).

In another aspect of the invention, there is provided a mineral whey product produced via the process as described above.

Now will be described, by way of a specific, non-limiting example, a process according to the invention, and a mineral whey product according to the invention.

### DETAILED DESCRIPTION OF A PREFERRED EMBODIMENT

The following is an example description of process according to the invention wherein clarified cheese whey is processed to form a mineral whey powder. In the following description, parts and percentages are by mass unless otherwise specified.

A feed stream of 73,446 kg of clarified cheese whey, containing 0.82% protein (based on TN×6.38), 0.08% fat and 5.14% non-fat solids, was nano-filtered (EPIL plant; DOW Filmtec NF45 membranes; MWCO 150-300 Daltons) to produce 52,999 kg of a stream of mineral-rich permeate, containing 0.55% total solids, 0.10% protein (TN×6.38) and 0.30% minerals.

Alternatively, an ion exchange process can be used instead of, or in conjunction with, the membrane demineralisation process.

The permeate was transferred to a reverse osmosis plant (EPIL plant; DOW Filmtec FT30 membranes) where it was concentrated to approximately 2.8% total solids.

The concentrated permeate was then heated to 80° C. by a combination of indirect heating and direct steam injection and held for 20 minutes. This caused the precipitation of a calcium-phosphate complex from the permeate. The calcium phosphate was then removed by a centrifugal separator (Westfalia

Separator, model MSD-60), leaving 9,810 kg of the feed stream containing 2.7% total solids, 0.45% protein (TN×6.38) and 1.45% minerals.

Alternatively, the calcium-phosphate could be removed from the feed stream using membrane filtration.

The feed stream was then concentrated to 60% total solids in a triple-effect falling film evaporator (Tetra Pak EC 500). Following concentration of this permeate, said evaporator was opened and found to be clean and free from fouling.

This is a particularly significant result, as prior art methods would be expected to result in quite significant fouling of the evaporator, with resultant loss of efficiency and downtime for cleaning.

Alternatively, it is possible to use further membrane processing, or a combination of membrane processing and evaporation to achieve the desired solids content.

The concentrate was then spray dried to produce 251 kg of mineral whey powder. The mineral whey powder contained 4.6% moisture, 15.9% protein (TN×6.38) and 51.2% ash of which only 0.3% was calcium. The powder was cooled and packed for use as an ingredient in food products.

Use of the resultant product in various food-related applications have revealed that it has an acceptable flavour profile. This whey product is particularly suited for use as an ingredient in low-sodium food products.

It will be understood by those skilled in the art that the concentrated product ex-evaporator need not be dried to a powder for storage or transport. It is equally possible to package the concentrate as is, or to further concentrate it into a paste without departing from the invention.

It will also be appreciated by those skilled in the art that the above is merely one example of how the inventive method may be put into effect. Methods may be employed which depart in detail from the above, but which remain within the spirit and scope of the invention.

1. A process for the production of a commercial mineral whey product derived from a feed stream of milk or whey comprising the steps of:
a) de-mineralizing the feed stream by either membrane separation or ion exchange thereby producing a high potassium stream and a demineralised stream;
b) de-mineralizing the high potassium stream by precipitation and subsequent separation of a predominantly calcium-phosphate complex, or by removing of calcium by ion exchange;
c) concentrating the high potassium stream to obtain a concentrate having a total solids content of around 20 to 60% by weight; and
d) processing further of said concentrated high potassium stream into a desired form for storage and distribution.

2. The process of claim 1, wherein said step of processing further of said concentrated high potassium stream includes removing moisture to produce a concentrate, paste or powder.

3. The process of claim 1, wherein precipitation of the calcium-phosphate complex is achieved by heating said high potassium stream to a precipitation temperature of between 50° C. and 99° C. and maintaining said high potassium stream in said precipitation temperature for a minimum holding time.

4. The process of claim 3, wherein said precipitation of the calcium-phosphate complex is achieved by heating said high potassium stream to said precipitation temperature of approximately 80° C. and maintaining said high potassium stream at said precipitation temperature for said minimum holding time.

5. The process of claim 4, wherein said minimum holding time is between 2 and 30 minutes.

6. The process of claim 5, wherein said minimum holding time is approximately 20 minutes.

7. The process of claim 1, wherein the resulting mineral whey product contains a non-dairy additive and said precipitation of the calcium-phosphate complex is enhanced by increasing the pH of said high potassium stream to the range of pH 6.5 to 9.0.

8. A commercial mineral whey product, said commercial mineral whey product being produced by a) de-mineralizing a milk or whey feed stream by either membrane separation or ion exchange thereby producing a high potassium stream and a demineralised stream; b) de-mineralizing the high potassium stream by precipitation and subsequent separation of a predominantly calcium-phosphate complex, or by removing calcium by ion exchange: c) concentrating the high potassium stream to obtain a concentrate having a total solids content of around 20 to 60% by weight; and d) processing further of said concentrated high potassium stream into a desired form for storage and distribution.

9. (canceled)
